(19) United States
(12) Patent Application Publication
(10) Pub. No.: US 2018/0158081 A1
(43) Pub. Date: Jun. 7, 2018

(54) System And Methods for Conducting One-Action Surveys

(71) Applicant: Chian Chiu Li, Fremont, CA (US)

(72) Inventor: Chian Chiu Li, Fremont, CA (US)

(21) Appl. No.: 15/368,571

(22) Filed: Dec. 3, 2016

(51) Int. Cl. G06Q 30/02

(52) U.S. Cl. CPC G06Q 30/0203

(57) ABSTRACT

Systems and methods for conducting survey or surveys using one action. In an aspect, multiple questions from an event are answered simultaneously by one action. In another aspect, multiple questions from multiple events are answered simultaneously by one action. In yet another aspect, one-action survey is configured on a user reviews webpage where user comments are entered and displayed.

### FEDERALLY SPONSORED RESEARCH

Not applicable

### SEQUENCE LISTING OR PROGRAM

Not applicable

### CROSS REFERENCE TO RELATED APPLICATION

This application is related to patent application Ser. No. 14/298,880, filed Jun. 6, 2014. This application is also related to patent application Ser. No. 14/194,793, filed Mar. 2, 2014, now U.S. Pat. No. 9,483,774, granted Nov. 1, 2016.

### BACKGROUND

### Field of Invention

This invention relates to conducting surveys, more particularly to using one action to answer multiple survey questions from one or multiple events simultaneously.

### Description of Prior Art

Customer surveys are important for all kinds of business. Surveys on social or political issues are also important for policy makers as well as the general public. For business, survey results may be used to monitor customer service, improve product quality, obtain early warning signals, observe future trends, etc. Conventional surveys use a questionnaire that includes multiple questions. The questions are often long and not easy to comprehend, and they often occupy several pages. No matter whether a questionnaire is on paper or on a screen, most people just shy away from it because, it is considered burdensome and intrusive. In many cases, only the allure of prize may make some people participate in surveys.

When there are multiple survey questions, it would be more efficient and timesaving if the questions could be answered together in a way like addressing one question. In following discussions, “address” as a verb may be considered to have similar meaning to verb “answer”. For instance, to address a question may mean to answer a question. In some cases, a question may be addressed by another question, i.e., a question may be answered by answering another question. Since conventional survey questions and answers are complicated, it is impossible to handle them simultaneously. For instance, answers of conventional survey question may include options like “extremely satisfied”, “satisfied”, “neither satisfied nor unsatisfied”, “unsatisfied”, and “extremely unsatisfied”. Assume that there are two questions to be surveyed. If they could be addressed simultaneously by one action, it would mean that the questions have the same answer out of five options, which seems impractical in most cases. As a consequence, survey questions have to be answered one by one in a tedious and time-consuming process. The trouble grows bigger when there are multiple surveys.

Besides surveys, user reviews webpage or websites are constructed for the purpose of getting and displaying customer feedback. On a reviews website, for instance, users or customers may write comments and give ratings on a business. Reviews and summary of ratings are usually accessible to all users. Some users may read them carefully before going to an event, like dining at a restaurant or purchasing a product. Although it is relatively simple and straightforward to post comments on a reviews website, in reality however, only a very small percentage of users ever did it. Maybe many users are busy or maybe many users don't like to write any essay.

Therefore, there exist a need for a simple and quick survey process where multiple survey questions may be answered simultaneously, and a need for an improved user reviews website so that more users may contribute opinions.

The word “event” as noun is referred broadly as something which physically or virtually happened, is happening, or may happen, and is suitable for conducting surveys. Examples include, but not limited to, shopping, dining, gaming, travelling, service, a class in school, a concert or ritual, political, cultural, religious or sport activities, political, cultural, religious issues and policies, or other personal or collective phenomena. Start of event may be the beginning of an activity, or appearance of a subject or issue. Examples of start of event may include beginning of shopping activity, announcement of a policy, publication of a personal, organizational, or national plan, or occurrence of any other phenomena. For some long-lasting issues such as attitude towards marriage, education, or politics, the event starting time may be long time ago. The end of event may mean a conclusion, closing, ending, withdrawal, or disappearance.

### Objects and Advantages

Accordingly, several main objects and advantages of the present invention are:
a). to provide an improved system and method for conducting one-action surveys;
b). to provide such surveys which are quick and convenient;
c). to provide such surveys which use one action to address multiple survey questions of an event simultaneously;
d). to provide such surveys which use one action to address multiple survey questions from multiple events simultaneously;
e). to provide such surveys which select survey question or questions automatically; and
f). to provide such surveys which arrange one-action survey and regular survey on user reviews website for users to express opinions.

Further objects and advantages will become apparent from a consideration of the drawings and ensuing description.

### SUMMARY

In accordance with the present invention, a single action may be designed to address multiple survey questions from an event simultaneously. The one-action multiple-question method is more productive and efficient compared to answering questions one by one. Similar method may also be used to address multiple questions from multiple events. One or multiple questions may be selected automatically to save one step for users. Furthermore, one-action survey window may be configured on user reviews website such that users may have another convenient option to provide feedback.

### DRAWING FIGURES

FIG. 1 is a block diagram describing one embodiment in accordance with the present invention.

FIG. 2 shows graphically one embodiment of one-action addressing multi-questions in accordance with the present invention.

FIG. 3 is a flow diagram depicting one-action multi-question survey in accordance with the present invention.

FIG. 4 shows graphically one embodiment of one-action addressing multi-questions from multiple events in accordance with the present invention.

FIG. 5 is a flow diagram depicting one-action multi-question survey in accordance with the present invention.

FIG. 6 is a flow diagram depicting process of one-action multi-question survey where the questions are either selected manually or automatically in accordance with the present invention.

FIGS. 7 and 8 show graphically embodiments of one-action survey configured on user reviews website in accordance with the present invention.

REFERENCE NUMERALS IN DRAWINGS

| | | | |
|---|---|---|---|
| 10 | Client System | 12 | Survey Database |
| 14 | Communication Network | 16 | Processor |
| 18 | Processing Module | 20 | Log Database |
| 22 | Computer Readable Medium | 26 | Wait Button |
| 24 | Close Button | 30 | Yes Button |
| 28 | Display Surface | 34 | So-So Button |
| 32 | No Button | 38 | Button |
| 36 | Button | 42 | Survey Window |
| 40 | Client System | 46 | No Button |
| 44 | Yes Button | 50 | Button |
| 48 | So-So Button | 54 | Survey Window |
| 52 | Display Surface | 80 | Client System |
| 56 | Input Window | | |
| 82 | Server System | | |

100, 102, 104, 106, 108, 110, 112, 114,
116, 118, 120, 124, 126, 128, and 130 are exemplary steps.

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types.

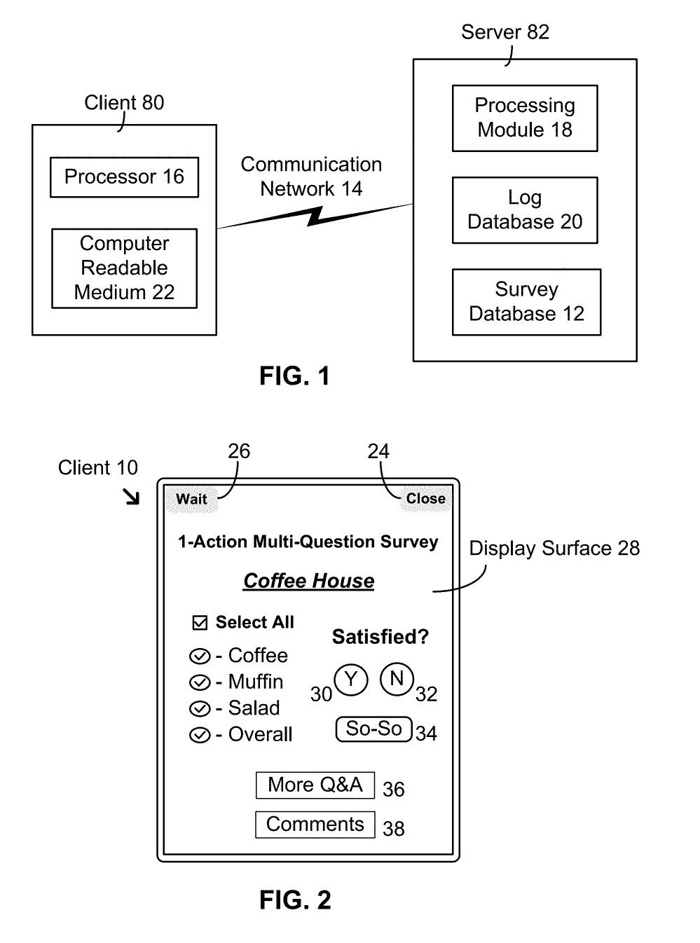

FIG. 1 is an exemplary block diagram of one embodiment according to the present invention. A client system 80 and server system 82 at survey center are connected via a communication network 14. Client 80 may represent an electronic device, including but not limited to mobile phone, smart phone, smart watch, other wearable device, handheld computer, tablet computer, desktop computer, virtual reality (VR) device, augmented reality (AR) device, and the like. Client 80 may include a processor 16 and computer readable medium 22. Processor 16 may mean one or more processor chips or systems. Medium 22 may include a memory hierarchy built by one or more memory chips or storage modules like RAM, ROM, FLASH, magnetic, optical and/or thermal storage devices. Processor 16 may run programs or sets of executable instructions stored in medium 22 for performing various functions and tasks, such as surfing on the Internet, placing phone calls, logging on a website, playing video or music, gaming, electronic payment, social networking, survey, sending and receiving emails, short messages, files, and data, executing other applications, etc. Client 80 may also include input, output, and communication components, which may be individual modules or integrated with processor 16. Communication components may connect the device to a server or another device via communication network. Usually, client 80 may have a display (not shown in FIG. 1 for brevity reason) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, tablet computer, smart watch, and certain wearable devices. A touch screen may be used as a convenient tool for user to enter input and interact with a system.

Furthermore, client 80 may have a voice recognition component to receive user's verbal command or audio input. In addition, client 80 may have a gesture detection mechanism to receive user's gesture instructions. For VR and AR devices and some wearable devices, virtual screen or screen having a very small size may be arranged. While it is inconvenient or impractical to touch such a screen, verbal command and gesture instructions may become useful for users. In discussions below, word “screen” may include virtual screen and screen with very small size, like smaller than one inch by one inch square or even smaller than a fingertip. A survey interface or survey window may be displayed on all kinds of screens.

The word “server” means a system or systems which may have similar functions and capacities as one or more servers. Main components of server may include one or more processors, which control and process data and information by executing software, logic, code, or carrying out any other suitable functions. A server, as a computing device, may include any hardware, firmware, software, or a combination. In the most compact form, a server may be built on a single processor chip. In the figure, server 82 may represent one or more server entities that collect, process, maintain, and/or manage survey information and documents, administrate certain surveys, communicate with users, deliver information required by users, etc. Server 82 may exemplarily be divided into three blocks, represented by a processing module 18, a log database 20, and a survey database 12. Processing module 18 may include processing and communication functions. Log database 20 may store user ID information and survey ID information, which may be used to trace a survey which a user participated in. Survey database 12 may store survey results and other survey related information, such as information on survey event. The databases may include a cluster of aforementioned memory chips and/or storage modules.

Communication network 14 may cover a range of entities such as the Internet or the World Wide Web, a local area network (LAN), a wide area network (WAN), a metropolitan area network (MAN), a telephone network, an intranet, wireless, and other types of networks. Via communication networks, client 80 may communicate with server 82 or survey center to send and receive data or messages.

Inside client 80, data received for user may be transmitted to processor 16, which, employed with certain algorithm, may process the data and act according to predefined programs. For instance, processor 16 may process data obtained from a survey session, transmit certain messages to survey center or a business involved, and then wait for instructions or new messages from the survey center or business.

FIG. 2 is an exemplary diagram of a client system 10 for illustrating embodiment of one-action multi-question survey according to the present invention. Client 10, as an electronic device, has a display surface 28, where information, messages, and interactive graphic objects may be presented. Interactive graphic objects may represent documents, applications, and functions, e.g., a textual file, photo album, browser, email, music, platform, etc. Display surface 28 is also a GUI by which a user may interact with a client system and/or a remote facility like survey center or processing center of a business. Surface 28 may be a surface of touch screen or touchscreen, which is sensitive to a touch or touches. In general, a graphic object in GUI of touch screen may be activated by a click on a mouse or more conveniently, by a tap using finger tip.

FIG. 2 graphically depicts a survey interface or survey window with a title “1-Action Multi-Question Survey”. The interface may appear after a user launches survey app or logs on a survey website. Survey app is a survey program created for application at a user device. Survey app or survey website may be designed by survey center. The survey, as shown in the figure, is about a business called “Coffee House”. There are four survey questions, “Coffee”, “Muffin”, “Salad”, and “Overall”. The questions may be related to a purchase the user made within a given period of time. Traditionally, these questions have to be answered one by one, causing at least four steps. In the figure, there is another question “Satisfied?” beside the question list. The single question is easy to read and quick to comprehend. The single question may be designed to combine respectively with all questions selected by user. A user may only need to answer the single question “Satisfied?” to answer all other questions. For instance, when the four questions are selected, “Satisfied?” may mean whether a user feels satisfied with the selected questions, i.e., whether a user is satisfied with coffee, muffin, salad, and overall experience respectively. Single question “Satisfied?” is bundled with all selected questions. Answer to the single question is the answer to all the selected questions. Thus when the answer is “satisfied”, it applies to all selected question such as coffee, muffin, salad, and overall.

Beneath question “Satisfied?”, there are three graphic objects or three answer buttons 30, 32 and 34. The buttons correspond to “Y” or “Yes” (satisfied), “N” or “No” (not satisfied), and “So-So” (average) respectively. The three buttons represent correspondingly three simple answers arranged for the single question. Traditional survey contains five or seven answers. Typical five answers may include very good, good, average, bad, and very bad. Due to existence of multiple positive and negative answers, five-answer and seven-answer formats not only are complex, but also make it impractical for one-action multi-question survey.

In real life, users or consumers may feel satisfied in many cases or most cases, e.g., when shopping or dining around town, which, after all, is what all businesses try very hard to achieve every day. Consequently, answers for many survey questions may most likely be “satisfied”. A user may check “Select All” box to choose all questions on the list, and then click or tap the “Y” button to answer yes to all the questions together, meaning the answer is “satisfied” for all questions. A click or tap on answer button may also be arranged to conclude a survey in one action. If a user doesn't like yes answer for one question, the user may first select all, then uncheck the question, and then click on “Y” button to address the rest questions simultaneously. Again, when answer choices contain two positive options, like “Satisfied” and “Very Satisfied”, a user may take some time to decide and may have to vote twice, i.e., performing two actions, one for “Satisfied” and the other for “Very Satisfied”. Thus it becomes hard to do one-action process.

It is obvious that not all questions are suitable for one-action multi-question method. For instance, a number, instead of “Satisfied?”, fits a question like “How many times have you shopped there?”. Hence, multiple questions for one-action process are chosen or arranged specifically for a purpose. In the present example, each of the multiple questions is designed or arranged such that it may be combined with “Satisfied?” to form a new question. Since “Satisfied?” is a question about satisfied or not, the answer is inherently simple. Thus the new question may be answered or addressed by answers like yes, no, or so-so. Assume that multiple questions are of the first questions and “Satisfied?' is of the second question. It is noted that first and second questions are mutually dependent. For instance, a first question should be constructed such that it may be addressed by a second question, or a second question should be constructed such that it may apply to a first question. In FIG. 2, coffee, muffin, salad, and overall at Coffee House as first questions may all be addressed by a second question “Satisfied?”. And “Satisfied?” as a second question may apply to each of the first questions, coffee, muffin, salad, and overall. As explained previously, addressing a question by another question may mean answering a question by answering another question. For instance, to answer question “Coffee”, a user may select the question and then answer another question “Satisfied?” by tapping a yes button, which indicates an answer to “Coffee” is “satisfied.” As first and second questions are related, a first question should fit the requirement of a second question and/or can be bundled with the second question to form a new question, and vice versa. When all the first questions can be bundled with the second question, any answer which addresses the second question may address all the bundled questions or all the first questions. Thus, if a second question needs a few answers, so do all of the first questions. When first questions have the same answer, they may be addressed simultaneously.

It is noted that regular survey questions can't be used for one-action multi-question surveys without screening. In addition, question format may have to be redesigned for one-action multi-question surveys. Since a list of questions is presented in a survey window, each question should be short and easy-to-understand so that a user may only need to take a quick review on the questions before answering them. Preferably a question arranged for one-action multi-question survey has only one word, like that shown in FIG. 2, or at most a few words only. For instance, question “Are store hours convenient for your dining needs?” may be changed to “Store Hours”, which may be addressed by “Satisfied?”. Similarly, question “The customer sales representative was polite” may be changed to “Politeness”, “Rep Politeness”, or “Sales Rep Politeness”. Hence, in order to fit one-action method, traditional questions may have to be simplified or shortened, or even deleted from a list if no proper alternative could be found.

There are other interactive graphic objects on surface 28. If a user doesn't want to take a survey, he or she may tap a “Close” button 24. There is also a “Wait” button 26 for users who may want to take a survey after a while. Tapping “Wait” button may keep the survey window open for an extended period of time. On the lower part, “More Q&A” button 36 and “Comments” button 38 are arranged. Button 36 may lead to a survey with conventional format like many questions and five or seven answer options, which some users may be willing to do. Tapping button 38 may open up a comment window in which users may post comments or reviews to express thoughts and feelings.

Although questions on the left side of FIG. 2 are related to one event, they may have different characteristics. “Overall” is a generalized question suitable for all events or occasions. The other three questions are of products or menu items carried by Coffee House. The three questions are specific and may be used only at the place. Thus one-action multi-question survey may contain universal questions suitable for different surveys and specific questions designed for one event only.

The above described survey may get started when a user launches survey app which is installed at a user device. Alternatively, a survey interface or window may appear on screen of user device after a user logs out of an online transaction or opens a follow-up email. Next, the user may take a quick look at a question list, select all questions, and then tap or click yes button to answer all questions. It may be designed that a step of answering questions may cause conclusion of survey session automatically. Thus, it is seen that a one-action survey process may be made simple, easy, swift, and efficient.

Back to FIG. 1. When a survey session is conducted via survey app at a user device, processor 16 may administrate it. However, when a survey is conducted via a website or email, server 82 or module 18 may get involved and may administrate a survey process. In the former example when survey app is used, survey related information, including case ID, user ID, survey result, and event info, may be sent to server 82 by processor 16 via network 14. In the latter example, related info may be collected by server 82 directly. Server 82 may store case ID, survey results, and event info in survey database 12, and keep user ID and case ID in log database 20. Alternatively, survey related information may be transmitted to a local device which then relays the information to survey center or server 82. In addition, survey-related information may be transmitted to another database at a business's facility in a near or remote place. For example, certain businesses or organization may want to keep to themselves survey-related data collected from customers.

Completing multiple questions with one action may make some users, who may otherwise ignore a survey, to provide valuable info. In addition, users who like to take a regular survey may tap button 36 to start a session conveniently. Users may also tap button 38 to open a comment window and leave comments. There may be options available for users to revisit and revise survey answers within a given period of time. Survey window shown here may be placed on screen of smartphone, tablet computer, desktop computer, other suitable devices, or even on virtual screen of VR and AR device.

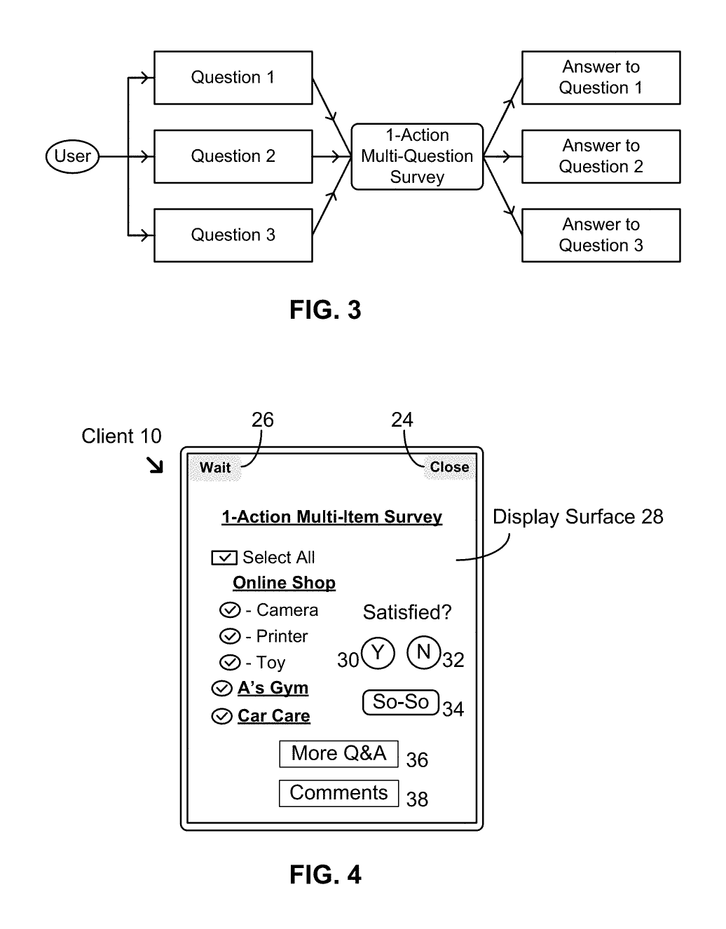

FIG. 3 depicts a one-action multi-question survey embodiment by exemplary flow diagram according to the present invention. In the figure, three survey questions are presented to a user. Assume the survey is about a car repair experience. Sample questions may include “Service Quality”, “Price”, and “Speed”. The user may go through a one-action process to address all questions simultaneously. For instance, the user may select all questions first and then activate a yes button beside a single question “Satisfied?” or “Are You Satisfied?”. Next, the survey session may end and survey results or answers to the questions may be transmitted to survey center or the repair shop through communication networks. Feedback data from users may be stored at the center or the shop.

FIG. 4 depicts graphically another survey embodiment. A survey interface or survey window shows a title “1-Action Multi-Item Survey” on surface 28 of client 10. The survey is about three events happened at three businesses, Online Shop, A's Gym, and Car Care. Most features and functions of survey interface remain the same as those in FIG. 2. Compared to multi-question survey, multi-item survey may cover both multiple questions and multiple events, as illustrated in FIG. 4. For instance, survey questions may be of “Camera”, “Printer”, and “Toy” regarding a shopping experience at Online Store, while the other two events don't include specific questions but a user may be surveyed on overall opinion. Again a check box is arranged for conveniently selecting all items, i.e., all questions and all events. For instance, when a user is satisfied with all items, the user may check “Select All” and tap or click “Y” button 30. Then three questions and two events are addressed with one action at the same time, that is, “satisfied” is the answer for all three questions and two events. Since the two events represent separate surveys, the method depicted in FIG. 4 actually use one-action to answer multiple questions from a survey and complete multiple other surveys simultaneously.

On the other hands, the two events may also be viewed as two questions from two events. For instance, “A's Gym” may be considered as a generalized question soliciting overall opinions on the business. Thus, the one-action multi-item survey of FIG. 4 may equal to one-action multi-question multi-event survey.

Moreover, regular survey questions which fit one-action process may be arranged for A's Gym and Car Care as well. For instance, under “A's Gym” in FIG. 4, questions like “Facility” and “Weight-Loss Program” may be displayed. Thus one-action multi-item survey may feature multiple questions for some or all events.

As multiple events are involved, activation of “More Q&A” button 36 may open up a window where several conventional surveys may be arranged. A user may make a choice and participate in one survey at a time.

As aforementioned, events as used here may be personal, collective, or business related activities, a process or journey, issues of all kinds, or any phenomena. Examples of event may include online shopping, in-store shopping, dining, service, gaming, show, sport, travel, educational, community, cultural or political policies, issues, and activities, and so on. In practice, event description shown in a survey window may be made concise and clear, such as “Shopping at Fresh Market” or “Fresh Market”, “Travel Package at Air Tour” or “Air Tour”, “Lunch at Café Cozy” or “Café Cozy”, “New Recycling Policy”, “Performance of Mayor John Doe”, and so on. As a survey target is mostly an event, multi-event survey equals to multi-surveys. As discussed in the above, each event or survey may have its own single or multiple survey questions.

Moreover, it may be arranged that a session begins with format of one-action single-question multi-event survey, where a survey interface or window shows a single question from each event or survey. A user may tap an answer button beside another single question like “Satisfied?” to address all events or surveys together. In some cases, a user may be willing to provide more detailed info beyond general thoughts. Thus, an interactive button may be configured on screen (Not shown in the figure). The button may be labeled “More”. Once “More” button is tapped, a list of questions may be displayed for each event. Then the survey becomes one-action multi-question multi-event survey, where each event may contain multiple questions and questions from all events may be answered by one action. In addition, another button, such as “Less” button, may be arranged on screen. A user may tap “Less” button to return to configuration of one-action single-question multi-event survey, where each event contains only one question.

“More” and “Less” buttons may be used for a single event survey too. For instance in FIG. 2, assume a “less” button is configured (not shown in figure). After “Less” button is tapped, the one-action multi-question survey may be changed to one-action single-question survey. For returning to multi-question mode, a “More” button may be arranged. Tapping “More” button may result in display of multiple questions in survey interface or window.

To fit individual needs, a small icon “More” may be configured beside each event name on screen. A user may tap an icon “More” to display all questions prepared for one event separately. For returning to one-question format, a small icon “Less” may be placed close to event name too. A user may tap icon “Less” to switch to one-question format for an event. Thus, a user may address either one question or multiple questions from each event selectively and conveniently.

Additionally, it may be designed that a designated question may be selected among multiple questions arranged for each event. A designated question may be on display in survey window when an event is only allowed to show one question. Survey center or a business may decide a designated question, which may be an event name or any specific inquiry like “Pricing”, “Usefulness”, or name of a product associated with an event.

For some events, two or more designated questions may be arranged for survey purpose. It may be arranged that designated questions represent the minimum quantity of questions an event may have. Thus, when an event is presented in a survey window, at least its designated question or questions may be displayed and ready to be addressed. Quantity of designated questions may have a limit, as too many questions may make it hard to read and lose effectiveness. Preferred quantity of designated question may be arranged from one to five. When there are designated questions, tapping “less” button may remove from survey interface questions except the designated ones. When “more” button is tapped, more questions may be added to a list of designated questions on screen,

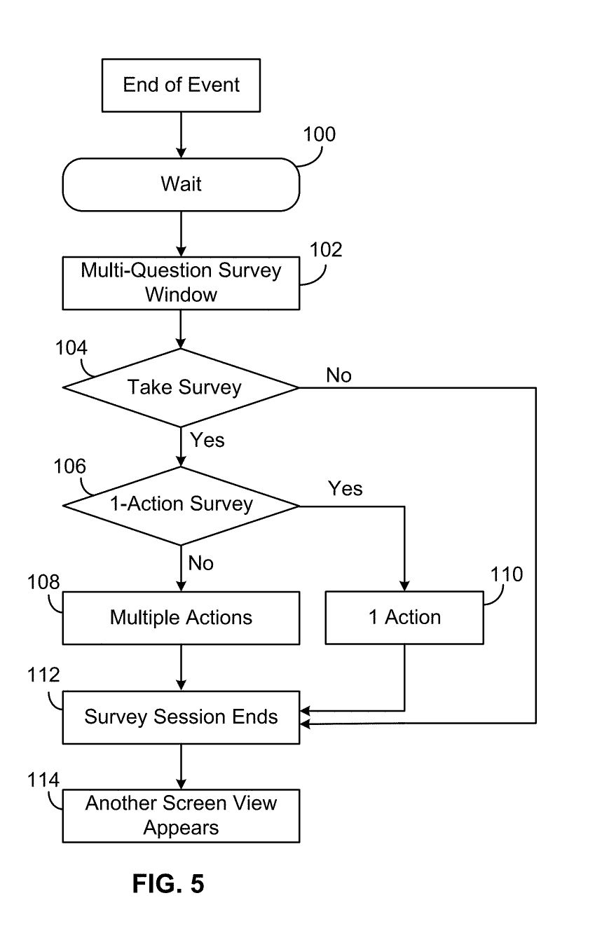

FIG. 5 shows a schematic flow diagram of multi-question survey process in more details. Assume a user purchased a product at an online store. The online store may record a transaction and wait for a chance to get feedback in Step 100. The store may send an email to the user after the user receives products. The email may contain a one-action multi-question survey as an embedded program. For instance, a survey window like the one in FIG. 2 may appear in the email in Step 102. Now the user is presented with two options, taking a survey or not taking it, after proceeding to Step 104. If the user doesn't want to do the survey, he or she may close the email page, which prompts termination of survey session in Step 112 and appearance of another screen view in Step 114. If the user wants to take the survey, he or she may decide to do a one-action process or take a traditional survey which requires multiple actions in Step 106. One-action multi-question survey may be conducted in Step 110, while a traditional survey with many actions may be conducted in Step 108. After either Step 110 or 108, the user proceeds to end of survey session in Step 112. Next, the user may exit the email page and enter another screen view in Step 114.

When a user chooses one-action survey in Step 106, the user may select all or some questions in the survey window and tap a yes button. Next, survey results may be sent to the online store, enabled by functions carried by the email.

Besides embedded in an email, a survey window may also be arranged to show up on a webpage. For instance, after a user finishes an online transaction, like purchasing an airline ticket or paying utility bill, and logs out, the next page may be configured to have a survey window among other contents. When a business adds a survey program functioning as survey module to its website, the survey program may cause appearance of survey window on logoff page and administrate a survey process when a user participates in it.

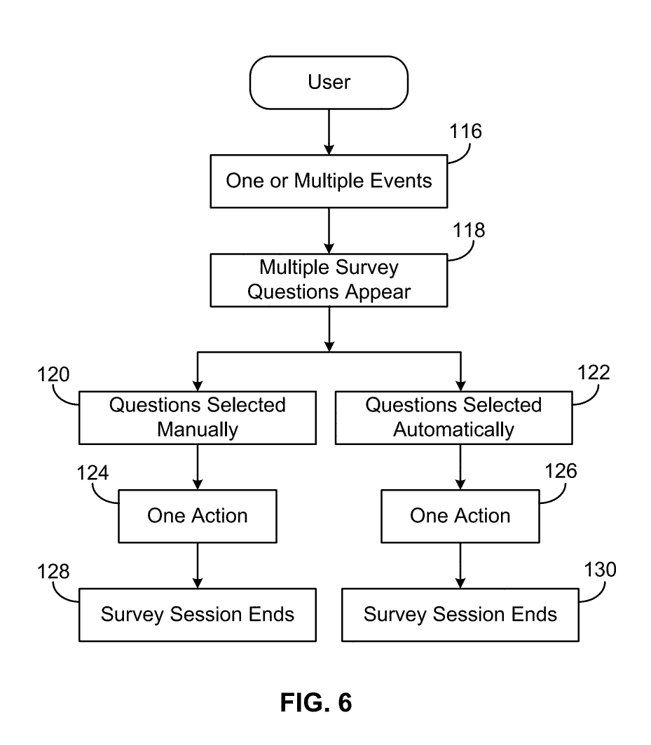

Another one-action multi-question survey is described schematically in a flow diagram in FIG. 6. A user may have participated in one or a couple of events in Step 116. Next, a survey window may appear at a user device to present a survey session which contains multiple questions in Step 118. The questions may concern one event or multiple events. As discussed in the above, a survey window may show up after a user launches survey app at user device, may appear on a webpage after a user logs out an online session, or may come with email contents after a user opens a follow-up email. The survey window may display a select-all box on top of a survey question list. As previously described, a user may check the select-all box to select all questions and then maybe remove check mark from one question, as in Step 120. Next, the user may tap or click a yes button beside a “Satisfied?” question to answer the selected questions in one action in Step 124. Then the session may conclude in Step 128.

Since a user may be satisfied in most events, such as in most dining and shopping occasions, the select-all box may be checked again and again at the beginning of many survey sessions. Thus, there exists a need to select all questions automatically when a survey window appears. For instance, after a user opens an after-transaction email, an email page may display a survey window with multiple questions. With auto-selection method, all survey questions may be selected automatically in Step 122, i.e., a check mark appears beside all questions automatically. The user may un-check one or two questions and may leave the rest checked. Next, the user may activate a yes button to implement a one-action process in Step 126 and the survey session may end in Step 130. Thus, compared with Step 120, Step 122 has one less move, since select-all step is performed automatically. The auto-selection method may save user's time and improve user experience as it may fit user's need.

Auto-selection method may also be designed to select one or part of available questions. For instance in FIG. 2, question “Overall” may be automatically selected, when a survey interface appears. Similarly, “Overall” and “Coffee” in the figure may be arranged selected at the beginning of a survey session. Next, a user may tap “Y” button to answer the selected one or more questions. Again, how many and what question is selected may be decide by survey center or a business involved. Selecting questions partially and automatically may make one-action multi-question survey easy to do in some cases, where questions may come from one or more events.

When deciding whether to go to a restaurant or purchase a product, it is helpful to read reviews on the place or product. The reviews are written by users who have been there or played with it. There are websites which are designed for user to contribute reviews and comments. Such websites provide convenience for users to write about personal feelings and observations on businesses and at the same time make it easy and simple for other users to find reviews and comments. User reviews websites, however, have a weakness which is related to writing skill and habit. Everyone may feel satisfied or unsatisfied on a business or product. On the other hand not everyone may want to write an essay to express feelings. Writing, after all, requires skills mastered by limited users only. Therefore, there exists a need to provide another input method besides writing on user reviews website.

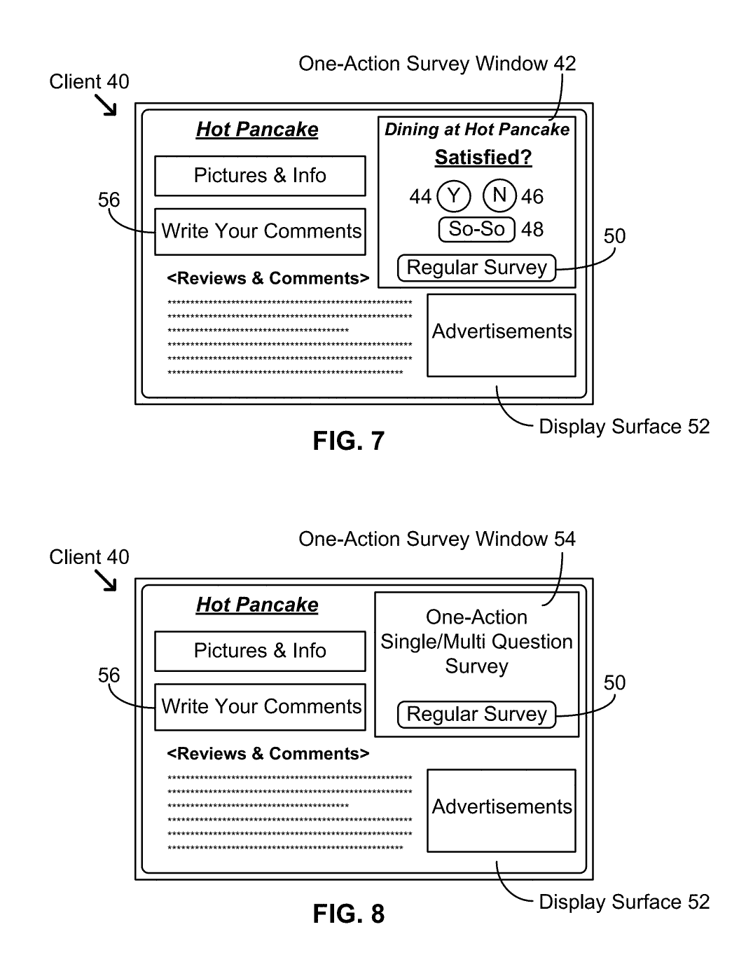

For users who prefer input method other than writing, one-action survey may be favored, as it is easy, simple, quick, and suitable for almost everyone. FIG. 7 shows graphically an improved user reviews webpage. The webpage is displayed on a surface 52 of a client system 40. Assume that a business under review is a restaurant Hot Pancake. There are pictures and texts to introduce the restaurant on the webpage. There are also advertisements. As designed, user generated reviews and comments take a prominent space. A user may write comments or reviews in an input window 56, where sign-in may be required to prevent abuse. Comparing to a traditional reviews site, a new feature is of a survey window 42. A one-action survey is presented with a title “Dining at Hot Pancake”. A single question “Satisfied?” is displayed along with three interactive answer buttons 44, 46 and 48 representing yes, no, and so-so or no comment respectively. The single question is arranged to obtain general opinions toward the restaurant from users.

Resultantly, when a user wants to express feelings or thoughts regarding Hot Pancake and is reluctant to write an essay or even a sentence, the user may just tap one of the three answer buttons. After a user signs in, which may be required for doing a survey, all it takes is just one tap or one click on an answer button. For users willing to express more or provide more feedback, a “Regular Survey” button 50 is configured in window 42. Once button 50 is activated, a conventional survey window may show up on screen, where elaborate long questions and complex answers may be presented. Thus for users who would like to review or comment a business, there are three options: Writing something, doing a one-action survey, or doing a regular survey. A user may write an essay and then take a survey. But for many users, writing may be too much and a one-action survey may be the preferred feedback means. It is noted that arrangement of regular survey is necessary so that valuable information may be obtained from a small percentage of users who may spend time answering questions.

“Satisfied?” in FIG. 7 reflects a general inquiry on restaurant Hot Pancake. When a user feels Hot Pancake is fine or okay in a general sense, the user may choose yes button. The question may be replaced by other question or questions as shown in FIG. 8, which resembles FIG. 7 except a survey window 54. The key element of survey window is of combination of one-action survey and conventional survey. As discussed, a one-action survey process may contain a single question or multiple questions from one or multiple events. One-action survey is arranged to attract the majority of users, while regular survey is prepared for some users who may spend extra time providing more detailed feedback. The two surveys target different user types and both yield valuable info from users.

For instance, depending on actual needs, a single question may aim at a specific issue like “Satisfied with House Pancake?” or “New Menu Is Good”, while three answer buttons remain the same and effective. When multiple questions are displayed in survey window, questions may use name or simplified name of menu items, such as “House Pancake”, “Stuffed Pancake”, and “Vegi Soup”. A user may select all items on display or just select one of them and then tap yes button to express satisfaction. It may provide a feasible way to get opinions on individual dishes. In case a user hasn't taken a survey which is about another event and the event happened within a given time period, the survey may be added to survey window too. Hence, survey window 54 may show a one-action multi-question survey or one-action multi-question multi-event survey.

Like discussed in other multi-question surveys, two kinds of icons, such as “Less” and “More” buttons, may be arranged in window 54 for each event or for all events. The buttons may be utilized to show single or multiple questions for selected events or all events in the window. Hence for users, it may be convenient to choose between spending less time answering a single question and spending more time answering multiple questions for any event. As discussed before, survey center or a business may select some question as designated question or questions for an event. In a default setting, a survey window may display designated question or questions for an event. When a “More” button is clicked or tapped, more questions may be added to a list on display. When “less” button is activated, only designated question or questions may show up in survey window.

As survey questions may be categorized as general opinions toward a business, service, or experience and specific thoughts on a feature or individual item, two switch buttons may be arranged in survey window to switch between two multi-question lists (buttons not shown in figure). When a button “General” is tapped, generalized questions may be displayed, like “Price”, “Service”, “Quality”, “Friendliness”, and “Overall”. When a button “Specific” is tapped, individual items like names of products, dishes, or programs may be displayed. For the latter, questions may look like the first three presented in FIG. 2 for Coffee House or questions in FIG. 4 for Online Shop. The method may apply to all cases involved multiple questions whether or not they are on a user reviews site.

A survey window arranged for reviews site may have a special feature. When a user logs on a reviews site, the user may have a tendency to engage in review and survey activities, as reviews and survey are what the site is arranged for. As a result, a survey window may be viewed as something a user desires to have, instead of an intruding and unwelcome object in some other scenarios. Thus, the window may remain on reviews page, no matter whether or not a user completes a one-action survey or regular survey. In a sense, as long as a user stays on reviews site, a survey window may be always configured ready for use in the interface. On the other hand, after a user read certain reviews or comments, his or her opinions may change. Thus there exists a need for a user to revise survey answer anytime. So, it may be desirable to provide an option such that a user may take a survey anytime or re-take a survey anytime when visiting a reviews site. Hence, surveys arranged on reviews site may be configured ready-to-go anytime or options to do survey on a reviews site may be arranged always available, even after a survey is completed or ended.

Every time after a user re-does a survey, whether one-action type or regular one, survey results may be transmitted to survey center and/or a facility of relevant business. The new data may be recorded and used to replace previous data received in the past.

For ease of use, after a user taps or clicks an answer button like button 44, 46, or 48 of FIG. 7, whether the first time or any other time, the button may be arranged to change in appearance in terms of shape, color, and/or brightness, while all three buttons may remain ready-for-activation at the same place. Thus, a user may easily recognize what answer is submitted and easily enter another answer when it is desirable. Similarly, after a user chooses to do a regular survey and exits after completing it, conventional survey icon like button 50 may change in appearance too. For instance, it may stay at the same spot, become brighter in color, and its label may change from “Regular Survey” to “Regular Survey: Start Over”. So a user may conveniently re-do a regular survey any time by tapping or clicking the survey button.

### Conclusion, Ramifications, and Scope

Thus it can be seen that systems and methods are introduced for conducting improved surveys.

The improved survey has the following main features and advantages:
(1). One-action is used to address multiple survey questions from an event simultaneously;
(2). One-action is used to address multiple survey questions from multiple events simultaneously;
(3). Survey questions may be selected for one-action process automatically; and
(4). User reviews site may contain options to do one-action survey and regular survey for obtaining feedback from users who don't like to write comments.

Although the description above contains many specificities, these should not be construed as limiting the scope of the invention but as merely providing illustrations of some of the presently preferred embodiments. Numerous modifications will be obvious to those skilled in the art.

### Ramifications:

Again assume that multiple survey questions are of the first questions and a single question like “Satisfied?” is of the second question. A second question may also be “Agree?” for first questions which concern issues, policies, attitude, etc. For instance, if a first question is “Shopping at Store A”, a second question “Satisfied?” is suitable. But if it is “0.1% Sales Tax Hike for School Improvement” or “Proposal to Build New Bridge”, “Agree?” may be the right second question. Alternatively, if first questions contain both experience and attitude topics, “Satisfied or Agree?” as second question may fit the need, as it is still concise and easy to understand, and suitable to answer with yes, no, and so-so.

Moreover, some first questions may need a yes or no answer, such as “Shop on Black Friday?”, “Plan a trip to ski?”, or “Vote for John Doe?”. Thus, a second question may be arranged as “Yes?”, which may be answered by yes or no. When such questions are mixed with other types of first questions, a second question may be configured as “Satisfied, Agree, or Yes?” or “Satisfied?/Agreed?/Yes?” along with yes, no, and so-so answers. Thus, when a yes button is clicked, it means the answer is satisfied, agreed, or yes for three kinds of first questions.

When first questions all require yes or no answer, a corresponding second question may be omitted. For instance, assume that first questions just contain above three questions which may be replied by yes or no. Then configuration of second question “Yes?” plus yes and no buttons may be replaced by the yes and no buttons only, since a question “Yes?” is implied in the buttons.

In addition, “Like?” may replace “Yes?” as a second question in some cases, such as in survey of dishes at a restaurant. Take eatery setting for example. It may be arranged that a list of first questions contains names of dishes on a menu. Survey center or a restaurant may decide which dishes are on the list. A second question may be “Like?” accompanied by yes, no, and so-so answer buttons. Alternatively, a second question “Like?” and answer buttons may be replace by a “Like” button or a “Like” and “Don't Like” buttons, since an individual second question may become unnecessary when the latter two sets of buttons are prepared. Thus, when a user likes selected dishes, the user may tap or click on yes button or “Like” button. As in other cases, option for regular survey may be arranged in survey window too, providing convenience for users who may want to do it. Also as discussed in the above, user's answer may stay in survey window, so that a user may easily check what was done last time. For instance, check marks may be arranged to stay with selected items, any button activated last time may appear differently compared to other buttons, such as showing darker or brighter color than other buttons. And a regular survey may show answers submitted last time, when a user re-visits it. After a user takes a survey, survey center or a business may obtain data, store it. Survey data obtained previously may be presented it on screen when a user re-enters a survey session within certain time.

Survey info submitted by a user may be arranged valid on a reviews website for a predetermined period of time, say one to three months. During the period of time, survey info which a user submitted previously may still appear in survey window after a user signs in on reviews website. For instance, after a user signs in, survey window may be arranged to show the same contents as last time before the user signed off on the website. The user may access and revise survey data when it is desirable. After the period of time passes, survey info may expire and survey window may be reset to a default state. Thus, a user may revise survey input conveniently within a given time period. As a user may either revise old survey data submitted in the past or submit new data when old data expires, survey center or a business may only receive one set of data from a user anytime. Hence, multiple answers to one question from a user within a given period of time may be prevented.

Sometimes, frustration or disappointment may happen, such as when a user returns a product due to quality issues, cancels an order because of delay of delivery, or files a complaint. In case a possibly uneasy thing occurs, a follow-up email may focus on negative opinions. For instance, while multiple questions may remain the same as discussed before, like “Price”, “Quality”, and “Delivery”, a single question to be answered directly may be changed from “Satisfied?” to “Unsatisfied?” to accommodate the tense mood. When a business deals with customer frustration, one-action multi-question survey is advantageous over one-action single-question survey, since multiple questions may cover more potential causes.

On a user reviews website like screen views of FIG. 7 or 8, a rating scheme may be arranged so that a user may rate a business, organization, and individual items like products and dishes. For instance, a user may choose from one star to five stars with five stars representing the highest mark. Five star-shaped icons may be configured in a row on screen. If a user taps the first star on the left, the user gives it one-star rating. If a user taps the third star from the left, a three-star rating is given. Rating results may be summarized by average method and displayed. Similarly, summary of one-action surveys may also be obtained and displayed on a reviews website. Thus, when a user visits a reviews website, the user may have four options to express feelings or give feedback: Writing an essay, one-action survey, regular survey, and rating. A user may take any or all options. And there are three ways for user to check and evaluate a business on a reviews site: Reading reviews and comments, viewing rating summary, and watching survey results.

Rating scheme may be arranged in survey window on user reviews website. It may be designed that a user may rate a business, which is featured on a reviews webpage, in two categories: Rating a business in a general sense and rating individual items carried by or related to a business. Take reviews webpage arranged for a restaurant for instance. A survey window may be configured on the webpage. A group of five star-shaped icons may be placed beside name of the restaurant and names of each dish on a survey list or list of first questions respectively. A user may rate the restaurant and any dishes by clicking or tapping an icon of a corresponding icon group. Similar to survey info a user submitted in survey window, user's rating records may remain valid and visible within a given period of time. Thus, when a user signs in within the period of time, rating input made last time may show up in survey window. For instance, a star-shaped icon activated last time may appear differently from the rest of icons in terms of color or brightness. It may be arranged that a user may keep rating results or change some ratings within the period of time. After the period elapses, rating records are reset to default state.

After a user taps an answer button to do a one-action survey, a survey result may be sent from a user or user device to survey center or a remote facility of a business. Next a survey window on screen may close or change contents automatically. If a survey session is conducted using survey app, a survey window may be closed after one-action process is completed. If a user wants to change answer or do a regular survey, the user may re-start survey app and tap a “History” icon to find the survey from a survey list. If a survey session starts from an email page or logoff page, a thank-you message may show up in survey window after an answer button is activated. While the thank-you message may replace a single question or multiple questions and answer buttons, a button for regular survey may stay in the window, continuing providing an option to do regular survey on screen. A user may ignore the button or tap it to enter a session.

Besides click and tap, verbal instructions may be used to select events and submit an answer, if a user device is equipped with voice recognition system. Thus a user may speak to a device to complete a one-action or regular survey session.

Lastly, various smartphone positioning technologies may be utilized to qualify a user for certain surveys. For instance, once it is detected that a user device enters the perimeter of a venue, such as a park, zoo, entertainment site, seminar room, concert hall, the info may be transmitted to survey center. Then the user may be enrolled in a survey on his or her experience at the venue.

Therefore the scope of the invention should be determined by the appended claims and their legal equivalents, rather than by the examples given.

1. A system arranged for working with an apparatus having a display and stored executable instructions, comprising:
A) communication component for enabling communication between said system and a survey center or a remote facility via an electronic device or a communication network;
B) survey means for presenting a survey session to a user, said survey means configured such that said display shows simultaneously a plurality of first questions arranged for an event;
C) said survey means configured such that said display presents a second question and a plurality of graphic objects representing answers for said second question, wherein each of said plurality of first questions is arranged such that it is addressable by said second question;
D) said system arranged such that reception of one of said answers which is submitted by said user at said system addresses said plurality of first questions simultaneously; and
E) said system arranged such that a survey result is transmitted to said survey center or said remote facility via said electronic device or said communication network.

2. The system according to claim 1 wherein said plurality of first questions is selected by said user respectively.

3. The system according to claim 1 wherein said plurality of first questions is selected automatically.

4. The system according to claim 1 wherein said plurality of first questions and said second question are arranged in an interface where user reviews are entered and presented.

5. The system according to claim 1 wherein said second question is arranged related to user satisfaction.

6. The system according to claim 1 wherein reception of one of said answers causes conclusion of said survey session.

7. The system according to claim 1 wherein said answers contain a positive reply, a negative reply, and a neutral reply.

8. A computer implemented method performed for conducting a survey session comprising:
A) arranging communication between a first device and a survey center or remote facility via an electronic device or a communication network, said first device having a display and stored executable instructions;
B) presenting said survey session to a user and showing simultaneously a plurality of first questions arranged for an event on said display;
C) displaying on said display a second question and a plurality of graphic objects representing answers for said second question, wherein each of said plurality of first questions is arranged such that it is addressable by said second question;
D) addressing said plurality of first questions simultaneously after said user answers said second question; and
E) transmitting a survey result to said survey center or said remote center via said electronic device or said communication network.

9. The method according to claim 8, further including obtaining user selection of said plurality of first questions.

10. The method according to claim 8, further including selecting said plurality of first questions automatically.

11. The method according to claim 8 wherein said plurality of first questions and said second question are arranged in an interface where user reviews are entered and presented.

12. The method according to claim 8 wherein said second question is arranged related to user satisfaction.

13. The method according to claim 8, further including concluding said survey session after said user answers said second question.

14. The method according to claim 8 wherein said answers contain a positive reply, a negative reply, and a neutral reply.

15. A computer implemented method performed for conducting a survey session comprising:
A) arranging communication between a first device and a survey center or remote facility via an electronic device or a communication network, said first device having a display and stored executable instructions;
B) presenting said survey session to a user;
C) displaying on said display a plurality of first questions arranged for an event for said user to select and displaying a second question simultaneously, wherein each of said plurality of first questions is arranged such that it is addressable by said second question;
D) showing on said display selected first questions after said user makes selections;
E) addressing the selected first questions simultaneously after said user answers said second question; and
F) transmitting a survey result to said survey center or remote facility via said electronic device or said communication network.

16. The method according to claim 15, further including selecting said plurality of first questions automatically.

17. The method according to claim 15 wherein said second question is arranged related to user satisfaction.

18. The method according to claim 15 wherein said plurality of first questions and said second question are arranged in an interface where user reviews are entered and presented.

19. The method according to claim 15, further including concluding said survey session after said user answers said second question.

20. The method according to claim 15, further including displaying a plurality of answers for said second question.
